(19) United States
(12) Patent Application Publication
(10) Pub. No.: US 2014/0025688 A1
(43) Pub. Date: Jan. 23, 2014

(54) DETERMINING, DISTINGUISHING AND VISUALIZING USERS' ENGAGEMENT WITH RESOURCES ON A SOCIAL NETWORK

(71) Applicant: MYSPACE, LLC, Beverly Hills, CA (US)

(72) Inventors: Michael Scott Andler, Los Angeles, CA (US); Thomas Barraud Werz, III, Los Angeles, CA (US); Eric Juhyun Kim, Tujunga, CA (US); James Andrew Beaupre, Los Angeles, CA (US); Timothy Charles Vanderhook, Newport Beachh, CA (US)

(73) Assignee: MYSPACE, LLC, Beverly Hills, CA (US)

(21) Appl. No.: 14/035,799

(22) Filed: Sep. 24, 2013

Related U.S. Application Data
(63) Continuation-in-part of application No. 13/858,857, filed on Apr. 8, 2013.
(60) Provisional application No. 61/705,131, filed on Sep. 24, 2012.
(60) Provisional application No. 61/621,057, filed on Apr. 6, 2012.

(51) Int. Cl. G06F 17/30

(52) U.S. Cl. CPC G06F 17/30861
USPC 707/748

(57) ABSTRACT

A method, apparatus, system, and computer program product for displaying top fan status information relating to selected content in a social network. An item of content is selected in a social network application. An engagement score is determined for each of one or more first users. Each engagement score is based on interactions of each of the one or more first users with the selected item of content. A subset of the one or more first users that has interacted with the item of social content the most is identified and displayed.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/705,131filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

This application is a continuation-in-part application of the following co-pending and commonly-assigned U.S. patent application(s), which is/are incorporated by reference herein:

U.S. patent application Ser. No. 13/858,857 filed on Apr. 8, 2013, entitled “System and Method for Presenting and Managing Social Media” by Michael Scott Andler, James Andrew Beaupre, Eric Juhyun Kim, and Thomas Barraud Werz III, attorneys' docket number 257.40-US-U1, which application claims the benefit of U.S. Provisional Patent Application Ser. No. U.S. Provisional Patent Application Ser. No. 61/621,057 filed on Apr. 6, 2012, entitled “System and Method for Presenting and Managing Social Media” by Mike Andler, James Andrew Beaupre, Eric Juhyun Kim, and Thomas Barraud Werz III, attorneys' docket number 257.40-US-P1;

This application is related to the following co-pending and commonly-assigned patent application(s), which is/are incorporated by reference herein:

U.S. patent application Ser. No. ______ filed on Sep. 24, 2013, entitled “System and Method for Connecting Users to Other Users and Objects in a Social Network” by Michael Scott Andler, attorneys' docket number 257.80-US-U1, which application claims the benefit of U.S. Provisional Patent Application Ser. No. 61/705,131filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

U.S. patent application Ser. No. ______ filed on Sep. 24, 2013, entitled “Hover Card” by Michael Scott Andler, James Andrew Beaupre, Eric Juhyun Kim, Thomas Barraud Werz III, and Kyle Kincaid, attorneys' docket number 257.81-US-U1, which application claims the benefit of U.S. Provisional Patent Application Ser. No. 61/705,131filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

U.S. patent application Ser. No. ______ filed on Sep. 24, 2013, entitled “Affinity-Tag Inheritance” by Michael Scott Andler, James Andrew Beaupre, Eric Juhyun Kim, Thomas Barraud Werz III, and Kyle Kincaid, attorneys' docket number 257.82-US-U1, which application claims the benefit of U.S. Provisional Patent Application Ser. No. 61/705,131filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

U.S. patent application Ser. No. 13/858,720, filed on Apr. 8, 2013, by Michael Scott Andler, James A. Beaupre, Eric J. Kim, and Thomas B. Werz III, entitled “System and Method for Determining User or Resource Influence within a Pre-Defined Context”, attorneys' docket number 257.43-US-U1, which application claims the benefit of U.S. Provisional Application Ser. No. 61/621,051, filed on Apr. 6, 2012, by Mike Andler, James Andrew Beaupre, Eric Juhyun Kim, and Thomas Barraud Werz III, entitled “System and Method for Determining User or Resource Influence within a Pre-Defined Context”, attorneys' docket number 257.43-US-P1; and

U.S. patent application Ser. No. 13/858,727, filed on Apr. 8, 2013, by Michael Scott Andler, James A. Beaupre, Eric J. Kim, and Thomas B. Werz III, entitled “System and Method for Recommending Content”, attorneys' docket number 257.44-US-U1, which application claims the benefit of U.S. Provisional Application Ser. No. 61/621,049, filed on Apr. 6, 2012, by Mike Andler, James Andrew Beaupre, Eric Juhyun Kim, and Thomas Barraud Werz III, entitled “System and Method for Recommending Content”, attorneys' docket number 257.44-US-P1.

### BACKGROUND OF THE INVENTION

1. Field of the Invention

This invention relates generally to social networks, and in particular, to a method, apparatus, system, and article of manufacture for determining/identifying/distinguishing and providing/visualizing users that are “Top Fans” of a resource on a social network.

2. Description of the Related Art

Prior art social network provide various mechanisms for users to socially interact with other users, music artists, bands, actors/actresses, companies, etc. Based on such interactions, businesses and public personas can develop a following. Further, businesses and public personas often utilize their social network pages to promote and advertise their business/public persona. What is lacking from such prior art social networks is the ability to identify those users who are “top fans” and/or who interact with the social network page contents to a greater extent than other users/fans. To better understand such problems, a description of prior art social network terms and interaction may be useful.

Prior art systems provide an overcrowded social network behavior terminology with respect to a user expressing an interest in other users and content. Such terminology includes friending, following, fanning, liking, checking in, +1-ing, etc. Each of these concepts allows a user to uni-directionally indicate an interest in another user/object/content. As an example, a “friend” within the Facebook™ social network is someone that a user may connect and share with within the social network. In other words, to express an interest in another user within the Facebook™ social network, a user may be required to search for and add that user as a “friend”. The added user must then “accept” that user as a friend to establish the “friend” relationship. Once friended, depending on the privacy/security settings established by the users, friends may have access to another friend's activity stream/updates, pictures, personal information, etc.

In addition to “friending,” to express an interest or to provide positive feedback and connect with things a user cares about, the user may “like” a web page, another user's post, etc. For example, if a user desires to indicate an interest in a concert venue, the user must search for and find a social network page corresponding to that venue and “like” that page. Once the user “likes” the page, the user may have access to/view that page's activity stream.

Another term used in the prior art is “follow” which provides a mechanism for a user to see public updates from the people a user is interested in. A user “follows” another user and will receive updates from the followed user in his/her own user's “news feed.” However, confusingly, if a user is interested in keeping up with a Page (e.g., businesses, organizations, bands, etc.), the user utilizes may be required to “like” the page.

“Fanning” is utilized in a similar manner to “liking” a page and refers to a user become a “fan” of their favorite page.

“Checking-in” refers to the concept where a user may “check-in” (e.g., using their mobile device/phone) at different places a user visits (e.g., bars, markets, concert venues, etc.). In other words, the user identifies a location that the user has visited using a “check-in” feature of a social network (e.g., on the Foursquare™ social network).

“+1-ing” refers to a method within the Google+™ social network for how a user shows their appreciation for a post/object. For example, a user may “+1” a post within the Google+™ social network by clicking a “+1” link/icon. Thereafter, the creator of the post and the people the post was shared with can see the user's “+1”. Users can also “+1” something on a website which adds to the total number of “+1”s shown in a count for that item.

What is lacking from each of the above prior techniques is the ability for the owner of a social network page to determine which users interact with the social network page beyond merely consuming content (e.g., a playing a song) of the social network page. In other words, prior art techniques fail to provide a system that identifies which users of a social network would be considered “top fans” of a particular product/business/public persona/etc. that is the subject of a social network page.

### SUMMARY OF THE INVENTION

Embodiments of the invention provide an identification and display of the most important/influential fans in a resource's (e.g., artist or profile) audience. Anytime a person interacts with a profile's content, that person's ranking increases. Further, any time that same person influences other user's to interact with that artist/profile, that person's ranking my increase (e.g., more than mere consumption/interaction with a profile's content). Accordingly, a display indicates an item of content's/resource's top fans.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the general structure and interaction within an social media network framework/system in accordance with one or more embodiments of the invention;

FIG. 4 illustrates exemplary symbols utilized to represent connections in accordance with one or more embodiments of the invention;

FIG. 5 illustrates the logical flow for inheriting tags in accordance with one or more embodiments of the invention;

FIG. 6 illustrates a top fan page available to a user of content/resource in accordance with one or more embodiments of the invention; and

FIG. 7 illustrates the logical flow for displaying top fan status information relating to selected content in a social network in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention. Embodiments of the invention include systems and methods for presenting and managing connections between users/objects on a social network.

### Hardware Environment

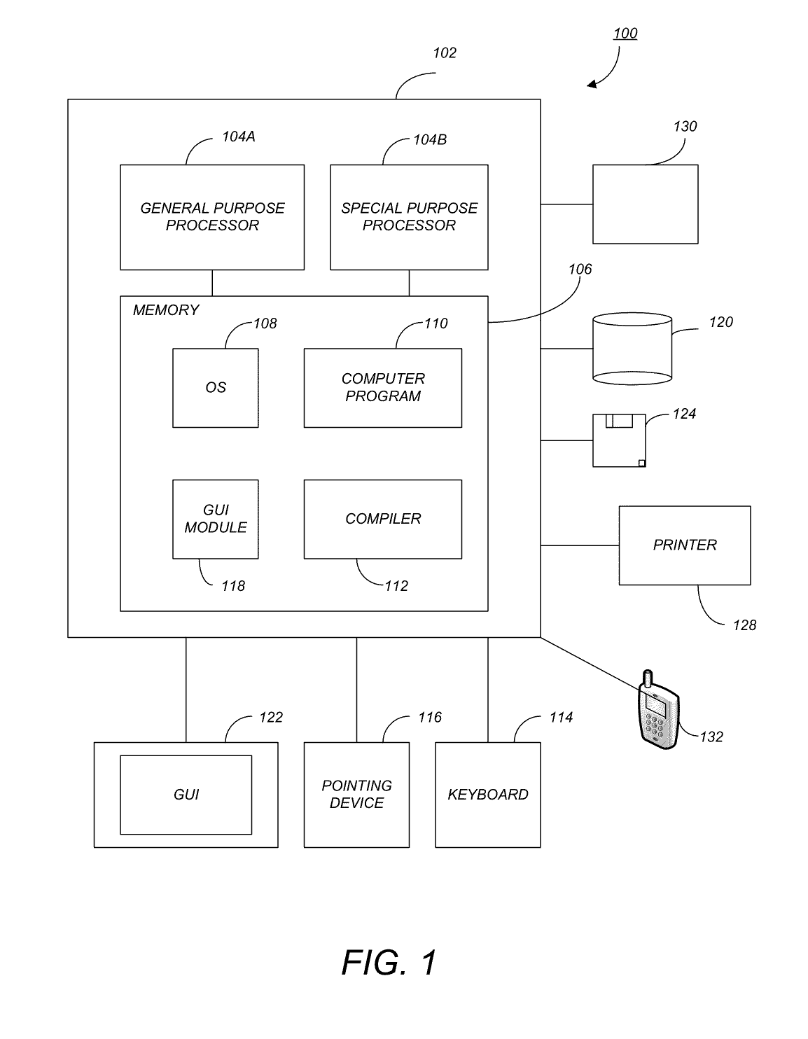

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

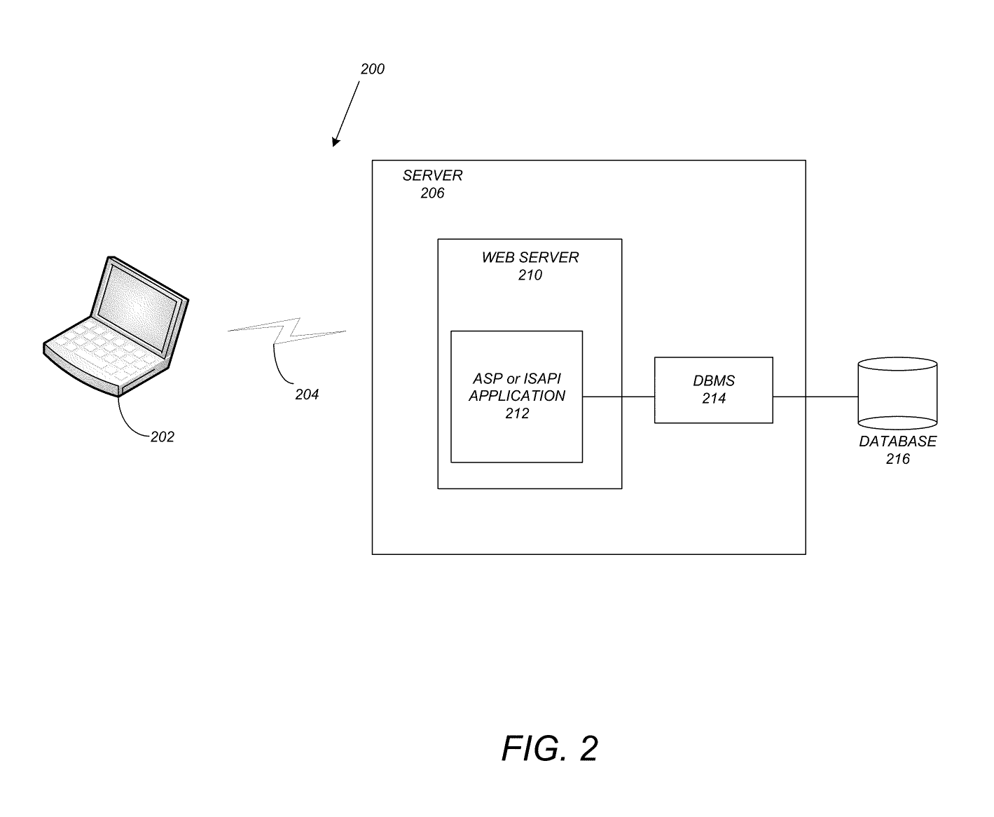

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### Software Embodiment Overview

Embodiments of the invention are implemented as a software application on a client 202 or server computer 206. Further, as described above, the client 202 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 202, portable device, etc.

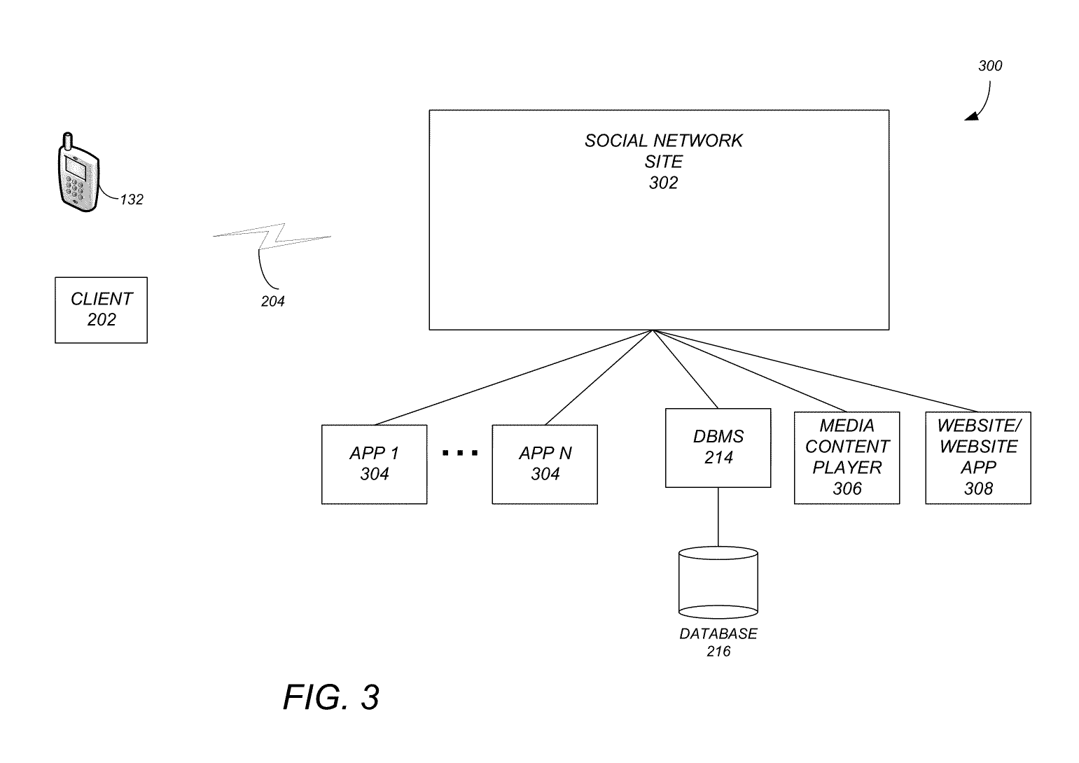

FIG. 3 illustrates the general structure and interaction within an social media network framework/system in accordance with one or more embodiments of the invention. As described above, mobile device 132 and/or client 202 (also referred to herein as user 202) may communicate and interact using a variety of networks 204 with various websites and applications. Mobile application software (commonly referred to as an “app”) may be installed and/or utilized on mobile devices 132 and/or clients 202. Such an app may be downloaded from an application marketplace or online store of applications. The app may be used to provide the functionality herein. In addition, various apps may be used in combination with server side applications to provide the desired functionality. For example, a user 202/132 may install an app on his/her smart phone or tablet device (e.g., iPad™) that is configured to communicate with a social network site 302 and display relevant information on the user's device. Information displayed via the app on the user's device may be pushed to the user's device or pulled from the site 302 depending on the configuration of the app.

On the server side 206, a social network site 302 (e.g., Myspace™ Facebook™, LinkedIn™, Friendster™, Twitter™, Foursquare™, Pinterest™, Instagram™, etc.), may provide an interactive experience to a variety of users 202/132 that access such a social network site 302. Users 202/132 may access social network site 302 via a web browser or via an app on the user's device.

Users 202/132 accessing a social network site 302 may be members of site 302 or may access information without being members. In this regard, access to a site 302 or certain areas of site 302 may be limited to users 202/132 that are members and are logged in to such a site 302. Such a logon may be automatic (e.g., preconfigured using cookies on a web browser or by storing a username/password on the user's device or in the app on the user's device).

Either as part of the social network site 302 or executing separately from the social network site 302, various applications 304-308 may be used to provide additional features to the social network site 302. It may be noted that the description is not limited to the applications depicted in FIG. 3 and additional applications may be used to provide the features described herein. Further, such applications 304-308 may be directly integrated with (e.g., are an integral part of) social network site 302, may interact with each other, and or may interact directly with the user 202/132.

Apps 304 may provide a variety of functionality ranging from games, to facial recognition, to media content discovery, etc. For example, one app 304 may consist of a recommendation engine that is configured to recommend content, events, etc. to a user 202/132 (e.g., based on content gathered and/or stored by social network site 302). DBMS 214 manages all of the data that may be stored in database 216. Media content player 314 enables the ability to view media content uploaded by users 202/132 (or uploaded by a host of site 302). Websites/website apps 308 are websites other than the social network site 302 (e.g., Twitter™, search engines, map-based interactions, etc.) that may use information from social network site 302 or provide additional information based on the social network information.

The platform and processing capabilities that provide an integrated graphical user interface that displays connectivity status and affinity between users/objects and may be performed by client 202, server 206, and/or a combination of client 202 and/or server 206 within a social network.

As used herein, a “social network” (or social network site) refers to a platform or service (e.g., website, web service, application, etc.) that enables users to build social relations based on shared interests, activities, backgrounds, and/or real-life connections. A social network provides a representation of each user (e.g., a profile), his/her social links, and a variety of additional services. As described above, many social networks/sites 302 are web-based and provide means for users to interact over a network 204 (e.g., the Internet, e-mail, and instant messaging). Social networking sites 302 allow users to share ideas, pictures, posts, activities, events, and interests with people in their network. Further, social networking sites 302 provide an electronic/computer-implemented means/representation of a social structure made up of a set of social actors (e.g., individuals or organizations) and a set of connections between such actors. In addition to providing the ability for users to connect to one-another, a social network 302 may also enable users to connect with groups (e.g., music groups), objects, locations, etc. However, embodiments of the invention are not intended to be limited to the social networks 302 described above but intend to cover any type of social network 302 where users can connect/communicate with one another and objects via electronic means.

### Connect Feature

The connect feature provides the ability for a user to connect to any piece of content or any user 202/132. In this regard, after logging in, a user 202/13 (e.g., a registered user/member) of a social network 302 may have the ability to connect to any of the following—people, artists, songs, videos, photos, albums, mixes (photos, music, etc.), etc. Connections are one-sided relationships—meaning that if a first user connects to a second user, the second user doesn't have to approve or connect back to the first user if they choose not to (except if the user is private, in which case they may have to approve a connection request). In this regard, privacy settings (of a logged-in user) may determine whether users can/cannot connect to a logged-in user. Such privacy settings may depend on whether a logged-in user's profile is public or private. If a logged-in user has a public profile, any user can connect to the logged-in user the logged-in user will receive a notification each time a user connects to the logged-in user. If a profile is private, the logged-in user will receive a notification each time a user initiates a connection with the logged-in user and the logged-in user will be prompted to approve or deny each request.

Accordingly, notwithstanding the specific case of a private user, once a first user has decided to connect to a second user, even that one-way connection allows the first user to see and comment on the second user's activities. If the second user chooses to connect back to the first user, then the mutual connection will allow the second user to see and comment on the first user's activities as well.

In view of the above, establishing a connection with other users, or artists, allows a logged-in user to view the other user's/artists latest activity. It may also expand a logged-in user's social graph and enable the logged-in user to explore shared connections, both people and content. Similarly, connecting to an object/piece of content (e.g., song, photograph, video, album, or mix), adds the object/content to the logged-in user's personal library for easy access and also places the object/content in the logged-in user's stream, making it visible to all of the logged-in user's connections, or the public, depending on the logged-in user's privacy settings. Connecting to content also improves a social network's ability to make recommendations for additional content the logged-in user may enjoy.

Such a connection feature simplifies the concept of “following”, “friending”, “liking”, or “adding” a user or piece of content—unifying a user's association with any object (users, photos, mixes, albums, songs, videos, etc.) on the social network site. Further, such a connection configuration provides a more accurate representation of relationships on the site (e.g., a user may follow an artist, but that artist doesn't need to follow the user back for the user to see their activity). Connecting to users and content helps a social network website collect more information on the user's interests (which may be used in the calculation of an “affinity” as described in related applications and also helps a social network site deliver better recommendations to users/members).

In view of the above, while the “connect” feature provides the ability for a user to “connect” to other users/objects, a “connections” feature organizes everyone (e.g., friends, artists) and everything (e.g., songs, images, albums) to which a user is connected. Connections may be accessed using a button within a social network website/application (e.g., within a contextual navigation menu) and can be filtered by type (e.g., the type of connection such as people [user-user], songs [user-song], albums [user-album], videos [user-video], photos [user-photo], etc.) (e.g., using a drop down menu or other selection technique). In addition, a “Top 8” feature allows a social network user to select up to eight (8) personal connections to be highlighted by displaying them directly on the user's profile (e.g., within a social network). Such a top 8 is determined by the user (unlike a Top Fans feature, which may be computed based on the level of interaction the user has with another user/group/object/etc.). In addition, a logged-in user may view all content/people to which the user has connected by visiting a library section found within a logged-in user's homepage. Such content/people in the library may be segmented by type.

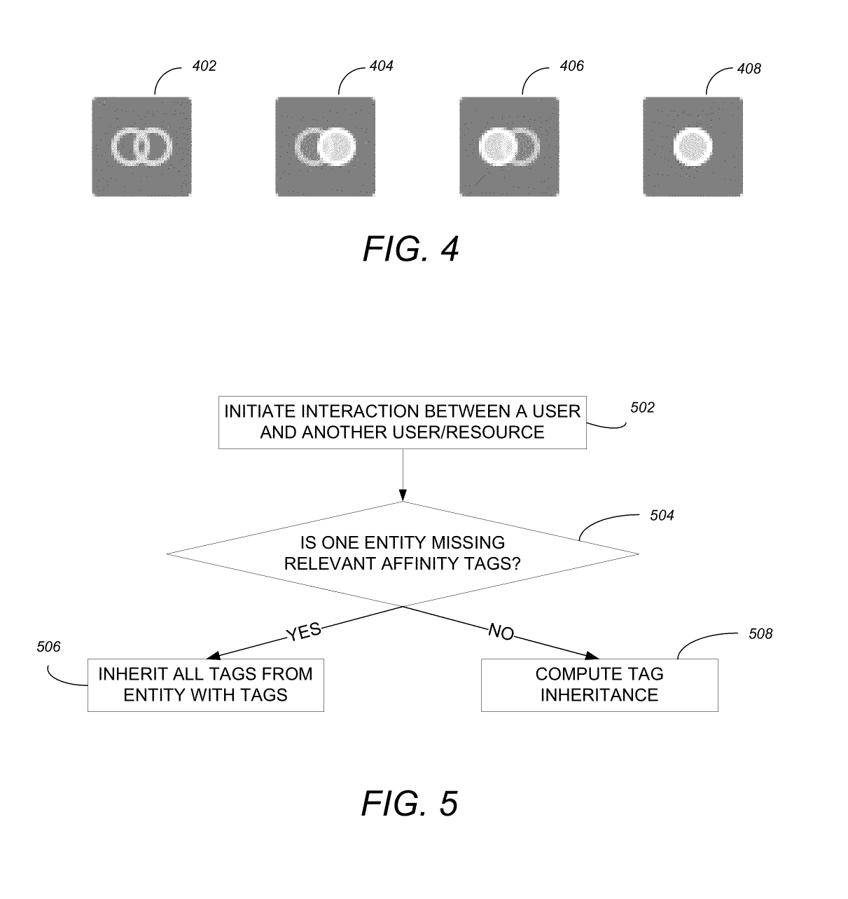

FIG. 4 illustrates exemplary symbols utilized to represent connections in accordance with one or more embodiments of the invention. Overlapping circles represent connections—much like a Venn diagram. The circles can be clicked like buttons to create, reciprocate or remove a connection. Thus, a user can simply click on one of the connection symbols 402-408 and the shading of the circles may change to indicate the change in the connection. In this regard, a change in the status of a connection will cause the symbol to change its appearance/state as described below. The transition from one state to another state may be animated (e.g. performed via an animation). Symbol 402 indicates that no connection exists between a logged-in user (e.g., you) and the object/user. Symbol 404 indicates that a user/object has connected to the logged-in user (e.g. you), but the logged-in user has not connected to the user/object. Symbol 406 indicates that the logged-in user has connected to a user/object, but the user/object has not connected to the logged-in user. Symbol 408 indicates a two-way connection (i.e., both the logged-in user and the user/object have connected to each other). In one or more embodiments when a user connects with a particular object, the reverse connection (i.e., from the object back to the user) is automatically performed resulting in the display of symbol 408. For example, if a user connects to/creates a song mix, there will automatically be a two-way relationship that results.

As an alternative to the symbols 402-408 of FIG. 4, other graphical user interface elements may reflect the connection status of the invention. For example, a chain with links of a chain closing (indicating a connection) and/or different arrangements of broken and closed links may be utilized.

When a user holds a mouse cursor over a connect symbol 402-408, information/options that are context sensitive to that particular connection may be displayed (e.g., in an H-card or other dialog box/display window). The information/options may be displayed in a variety of manners. For example, the information/options may be displayed within a drop-down menu with several options to engage with the connected object/person outside of connecting. For example, if the user hovers over a song, the options may display options that are relevant to songs including the connection status, an option to add the song to a playlist, to play the song, to create a radio mix with that song, share the song (e.g., on the user's stream or with a particular set of users), report a song (if its improperly tagged or has the wrong information), make the song the user's profile song, etc. Similarly, if a user hovers over a connect icon associated with another user, options may include “connect” and “share” (which may share the user's profile over the current user's stream)(e.g., with the option to make a comment such as “cool user profile”).

In one or more embodiments, the concept of sharing (both internally and external broadcast to other sites/services) may be incorporated within the set of dialogs and behaviors of the connect feature/control. For example, upon connection to a resource, the dialog may prompt the user whether he/she'd like this connection to be broadcasted to Facebook™/Youtube™, etc. (depending on that user's connect/privacy settings). In this regard, broadcasting a connection is synonymous with sharing, and will facilitate the viral spread of content in precisely the same manner. Additionally, “thumbs up” and “thumbs down” activities may also be incorporated into the connect feature/control. For example, upon mouse-over of the universal connect icon/symbol, a dialog may prompt the user with questions such as “Connect to more content like this?” or “Connect to less content like this?”. The response to this set of carefully worded questions may provide similar utility as “thumbs up” and “thumbs down” controls.

### Tag Inheritance

The basic premise of tag inheritance is that users and resources exchange affinities with one another by way of their interactions. The underlying assumption is that there is always a reason a user will interact with a resource (song, video, etc.), and ultimately this interaction indicates that there are things in common between them. In other words, tag inheritance is an exemplary process of identifying/altering affinities for resources and users in real time via the collection of stream data. This is accomplished through analyzing the behavior of users in a system.

By employing the system of tag inheritance, affinities may be calculated to represent the weights of tags against corresponding resources in the system. Such an affinity calculation is described in further below.

A key exemplary concept of an inheritance methodology is that users and resources inherit affinities from one another as interactions occur. Further, affinities are represented as tags. FIG. 5 illustrates the logical flow for inheriting tags in accordance with one or more embodiments of the invention.

At step 502, an interaction between a user and another user/resource/content is initiated/conducted.

At step 504, a determination is made regarding whether one of the interacting entities is missing/does not have relevant affinity tags. In this regard, whether a tag is relevant is based on the interaction and type of entities. For example, if a user is interacting with a song, and a user's affinity tag indicates a preference for restaurants located in Boston, such a tag would not be relevant to the interaction between the user and the song. However, if the user is interacting with the song and a user's affinity tag is categorized as a genre tag and indicates a 30% affinity for country music, such a tag would be relevant. Thus, the relevancy of a tag is based on the type of entities that are interacting with each other (and the categorization of the tag itself [e.g., genre, sports, food, people. etc.]).

If one of the interacting entities does not have a relevant affinity tag, such an entity inherits all of the tags from the entity with the tags at step 506. Example 1 illustrates the concept of steps 504-506:

### EXAMPLE 1

1. User A has no tags

2. Song 1 has the following genre tags:
a. Rock: 70% affinity
b. Country: 30% affinity

3. User A plays Song 1

4. User A inherits the following tags:
a. Rock: 70% affinity
b. Country: 30% affinity

In Example 1, Song 1 does not inherit any tags (because User A has no tags for Song 1 to inherit). Example 2 also illustrates the concepts of steps 504-506:

### EXAMPLE 2

1. User A has the following tags
a. Rock: 35% affinity
b. Country: 15% affinity
c. Soul: 30% affinity
d. Hip Hop: 20% affinity

2. Song 3 has no tags

3. User A plays Song 3

4. Song 3 inherits from User A and has the following tags:
a. Rock: 35% affinity
b. Country: 15% affinity
c. Soul: 30% affinity
d. Hip Hop: 20% affinity

In contrast, if both interacting entities have relevant affinity tags, both entities inherit tags of the other entity. Further, such an inheritance may affect the existing tags of the entity. Accordingly, the how and what tags are inherited may be computed at step 508. Such a computation may be performed based on a number of methodologies.

Example 3 illustrates one manner in which tags may be inherited by a user interacting with a song.

### EXAMPLE 3

1. User A has the following tags
a. Rock: 70% affinity
b. Country: 30% affinity

2. Song 2 has the following genre tags:
a. Soul: 60% affinity
b. Hip Hop: 40% affinity

3. User A plays Song 2

4. User A inherits tags from Song 2 and has the following tags:
a. Rock: 35% affinity
b. Country: 15% affinity
c. Soul: 30% affinity
d. Hip Hop: 20% affinity

5. Song 2 inherits from User A and has the following tags:
a. Rock: 35% affinity
b. Country: 15% affinity
c. Soul: 30% affinity
d. Hip Hop: 20% affinity

Thus, both User A and Song 2 inherit tags from each other and the existing tags are modified based on such an inheritance. It may further be noted that the type of interaction may also affect whether tags are inherited and the methodology used to compute the inheritance. For example, if a user plays a song, such a play interaction may partially affect the user's affinity tags. In contrast, if a user “connect” with or “likes” a song, such an interaction may have a greater impact on the user's affinity tags. A similar affect may result if a user merely watches a comedian's uploaded video versus the user “connecting”, “following”, “friending”, or “liking” the comedian or the comedian's video.

The amount one resource inherits from another may be determined by the strength of the tag, which is the percentage. That percentage may be converted to a raw score to be used in the calculation of the new percentages for each respective resource. Example 4 illustrates the conversion and use of raw scores in accordance with one or more embodiments of the invention:

### EXAMPLE 4

1. User A has the following tags:
a. Rock: 70%—Raw Score: 0.7
b. Country: 30%—Raw Score: 0.3
c. Total Raw Score: 1.00

2. Song 1 has the following Tag:
a. Soul: 60% affinity—Raw Score: 0.6
b. Hip Hop: 40% affinity—Raw Score: 0.4
c. Total Raw Score: 1.00

3. User A plays Song 1

4. Updates to User A
a. Raw Score increases by 1.00 (0.6 from Soul & 0.4 from Hip Hop)
b. New Raw Score total: 2.00
c. Rock: 35%=(0.7/2.00)*100
d. Country: 15%=(0.3/2.00)*100
e. Soul: 30%=(0.6/2.00)*100
f. Hip Hop: 20%=(0.4/2.00)*100

5. Updates to Song 1—Same formula as above

Accordingly, to compute the affinity values, the total raw score value is incremented, and the remaining raw score for each tag is divided by the new total raw score. Further, this new total raw score and adjusted values may be maintained as part of the tags associated with the user/entity. Thus, following example 4, if User A interacts with another song—Song 2, User A's initial raw score would be 2.0 and then combined with the total raw score of Song 2.

Alternatively, the raw score values may first be normalized prior to combining In this regard, the values of the entity being updated would be normalized by its total raw score while the entity it is interacting with would be normalized to a value of 1.0. As an example, when combining/computing the affinities of User A with Song 2, User A's initial raw score would be 2.0 (and it's affinity values would be normalized) but the raw score of Song 2 would first be normalized to 1.0 and then combined. Example 5: illustrates such a scenario:

### EXAMPLE 5

1. User A has the following tags:
a. Rock: 70%—Raw Score: 1.4 (0.7*2)
b. Country: 30%—Raw Score: 0.6 (0.3*2)
c. Total Raw Score: 2.00

2. Song 1 has the following Tag:
a. Soul: 60% affinity—Raw Score: 1.2 (0.6*2)
b. Hip Hop: 40% affinity—Raw Score: 0.8 (0.4*2)
c. Total Raw Score: 2.00

3. User A plays Song 1

4. Updates to User A
a. Normalize Song 1's raw scores to 1.00
   a. Soul: 60% affinity—Raw Score: 0.6 (0.6*1)
   b. Hip Hop: 40% affinity—Raw Score: 0.4 (0.4*1)
   c. Total Raw Score: 1.00
b. Raw Score (of User A) increases by 1.00
c. New Raw Score total: 3.00
d. Rock: 47%=(1.4/3.00)*100
e. Country: 20%=(0.6/3.00)*100
f. Soul: 20%=(0.6/3.00)*100
g. Hip Hop: 13%=(0.4/3.00)*100

5. Updates to Song 1—Same formula as above but the total raw score of User A is normalized to 1 and Song before updating Song 1's tags.

As illustrated by Example 5, as a user plays more songs and develops a set of affinity tags, subsequent song plays would not have as great of an impact on the user's affinity tags.

While the above reflects one method for combining/computing affinity tags, embodiments of the invention are not limited to any particular method but instead are directed towards the concept of tags being inherited based on interactions between a user and another user/entity.

In alternative/exemplary embodiments, a resource can only pass on a tag to another resource if it has inheritance occurrence count of X. That X is a configured value and the purpose of this logic is to minimize the exacerbation of user choices that are not representative or their preferences. The amount inherited per tag may decay proportionately in percentage from the inheritance distance level of the originally seeded tag. In addition, a user may only pass on its tags to a resource once every X interval. Such a configuration prevents the possibility of a user passing on its tags multiple times, which results in the possible scenario of the resource having strong improper characterizations.

The above examples use genre as the tag type, but the system is designed to handle any number of Tag Types. For example: Locations, Age, Gender, and User Entered Free Text tags (e.g., Hash tags), among others. Exemplary uses for this include, but are not limited to song recommendations (e.g., in Radio Mode) and event recommendations.

In addition to the above, the z-score (which is generated from the normal distribution graph comprised of the scores of a specific tag across the entire population) may be used to order applicable tags when calculating affinity between two resources.

Based on the above description, tag inheritance may be utilized in a variety of different scenarios. As an example, tag inheritance may be used to generate a similarity score between two objects (e.g., user to user, user to content, and/or content to content). In addition, tag inheritance may be used to recommend resources to users (e.g., songs, videos, pictures, etc.). Further, tag inheritance may be used to provide user-to-user recommendations.

To provide recommendations utilizing tag inheritance, a variety of different methodologies may be utilized. As an example, a list of candidate resources may be generated by a method of matching tag patterns from an inputted set of tags to an entire tag inheritance repository (referred to as “Tag Patterns”). Alternatively, a more granular ranking and sorting can be performed by comparing the inputted tags against all of the tags of the candidate resources to generate a similarity score.

In view of the above, the general concept of tag inheritance is that two entities (e.g., a user and another user/resource/object) interact with each other and such an interaction results in the exchanging of tags associated with each entity. Different methodologies may be used to weigh how much one entity will inherit a tag from another entity based on the overall set of tags that an entity has. Accordingly, if a song already has fifty (50) different genre tags, playing the song may have a small effect. Similarly, if the song has a large amount of rock influence already applied, and the user has a very strong rock affiliation, then it may further weight the rock affiliation of the song (and the user).

### User Engagement Rating and Display—Top Fan

Embodiments of the invention may include and rely upon systems and methods for tracking user interaction with content, including communicating (e.g., to a publishing service application upon user interaction with content) an identity of a user, an identity of content interacted with, and an engagement type. Such information (in addition to other factors and information) may be used to determine whether a user is considered a “top fan”.

As used herein, a top fan and/or top fan tool is a fundamental social network resource owner tool, offering the ability for a resource owner (e.g., artist, playlist, celebrity, business, etc.) to identify their “top fans”. As used herein, the term “top fan” may be loosely defined and may be used to distinguish type of fans, defining “top fans” as those users who go beyond exhibiting passive interest through consumption. In this regard, with respect to an artist/music, top fans may be users who directly interact with an artist, or piece of content, by listening, connecting, sharing, or adding to a mix.

Top fans may be characterized and ranked based on their willingness and ability to act upon and evangelize around their passions. Further, the determination of whether a user is considered a “top fan” may be based not only on the type and manner in which a user has engaged with a resource, but whether such a user's interactions with the resource has caused other user(s) to engage with such content (referred to as virality). As a specific example, a user may be considered a top fan if such a user has listened to content on a social network site, and as a result of that shared activity, other users have been referred to/consume that artist/piece of content/resource. In this regard, the number and amount of such other users accessing/consuming content based on a first user's activity may affect the user's “top fan” status or the user's ranking within a list of top fans.

Engagement Score

As used herein, a user's engagement score identifies a user's level of engagement/interaction with another user, website, resource, etc. An engagement score may be categorized by the type of engagement. Further, the level of engagement/interaction may be determined using a variety of mechanisms/methodologies. To enable the engagement score to have some meaning, various different methods may be used to place the engagement score into the appropriate context.

Scoring Engagement Types Against Population

To add context/meaning to a user's engagement score, a user may be provided with a percentile ranking against some or all of a social network site. To provide such a context/comparison with respect to a social network site, statistical models may be used, e.g., Standard Score/Z-Score, Standard Deviation, and Percentile Ranking

In one or more embodiments, the standard deviation and mean are calculated across a network site at regular intervals. This interval may be any desired interval and/or defined time period, e.g., on the order of minutes, hourly, across multiple hours, etc. The degree of near real-time performance may be balanced against performance as desired.

The calculation of the Standard Deviation and Mean will create the Normal Distribution, which a user's engagement value/score can be plotted against. As the user's value/score increases, so will the user's position on the curve.

A level of inaccuracy may be introduced as the interval between the calculations of the standard deviation and mean increases. Such an inaccuracy results because other user's values are changing independently from the curve. Once the curve is re-calculated, the users' positions may be adjusted. Nonetheless, the inaccuracies between calculation cycles may be corrected using historical data (e.g., by using the historical data to determine or estimate projected user's engagement values/scores).

In addition to the above, the plot may also be utilized to illustrate a user's score with respect to a specific population/group of users. However, such a plot may be more complex and expensive to perform, thereby potentially reducing the frequency at which the value can be calculated and plotted.

Normal Distribution

User scores for any given engagement value may be plotted against the normal distribution of the population (e.g., represented by a bell-shaped curve). The mean of the population and a standard deviation may define such a curve. A simple formula can be applied to the user's value in real time to get the user's position on the curve. The curve may also be updated by re-calculating the standard deviation and mean on a regular interval.

Calculating Mean

The mean (i.e., average engagement score) of the population can be calculated in parallel on each database (containing user profiles) at the same time. This allows the system to scale the process, giving linear performance. Better performance means the ability to recalculate more frequently. The following equation can be used to calculate the mean x̅ (for an engagement score x with a population n)

$$\overline{x} = {\sum }_{j = 1}^{n} {x}_{j} / n$$

The mean may then be adjusted against the % of population on each database. For example: Myspace™ social network may have 800,000 users who are part of the calculation. The entire site has 100,000,000 users across all profiles involved in the calculation. The mean for the Myspace™ social network would be multiplied by 0.008 (800000/100000000). This weighted average would be summed for each profile range to create the average mean for the site.

Calculating the Standard Deviation

The standard deviations 104 can be calculated in parallel by using the raw score method based on the following equation:

$${σ}^{2} = \frac{\sum {X}^{2} - \frac{{( \sum X )}^{2}}{N}}{N}$$

where σ is the standard deviation, S is the engagement score, and N is the total population.

In exemplary embodiments, the components of this calculation may be summed on each profile range. The summed values may be centralized to produce a global standard deviation to normally distribute user activity.

Using the Standard Deviation and Mean to Produce a User's Rank

In exemplary embodiments, generating the location of a value along the curve as defined by the standard deviation and mean may be performed using a standard score method. The standard score (also known as Z-Score) provides the position of a value along the curve. This Z-Score can then be used to generate a user-facing ranking, or simply converted to a percentile.

$$z = \frac{x - μ}{σ}$$

where x is the engagement score, μ is the mean, and σ is the standard deviation.

Exemplary Implementations of Distributed Statistical Ranking

A distributed statistical ranking can be utilized in/for a variety of different implementations. The descriptions below provide examples of some of these implementations.

User Relevance

The system may use action points or discovery points to calculate a user's percentile ranking relative to the other users on the site. The relative percentile ranking may be calculated over various time periods, such as one (1) day, seven (7) days, one (1) month, and all time. Further, the relative percentile ranking may be tracked over time to determine whether a user's ranking relative to other users has increased or decreased. If desired, a user's ranking may also be shown among their friends, as well as showing how this has changed over time.

Dashboard

The relative ranking for a user or any piece of content that they own can be displayed in a dashboard. Users may also be given an “at a glance” view of how they are doing relative to everyone else on a social network using charts and graphs, spider web charts, etc. (e.g., within a dashboard). As used herein, a dashboard refers to a toolbar, tool, application, and/or window that can be used to provide information or to select services/applications.

Levels for Reputation

One way to assign levels to a user is to just use their distributed rank. For instance, if a user is in the 58^{th} percentile, the user may be assigned to level 58. This will mean that a user's level will go down if the user stops interacting with the site, if people stop interacting with the user, etc.

Top User Influence

Top users may be permitted to influence the direction of a product/application (e.g., Myspace™ social network). In this regard, once the distributed statistical ranking is obtained, top users on a social network, based on their relevance ranking (e.g., from the distributed statistical ranking or from another website/application that provides the ranking), may be allowed to have a direct line of communication with social network development teams. Users' suggestions may be used, e.g., to create a product backlog, which can be broken up vertically or handled all by one team. Thereafter, social networks may actually implement what users are asking for. A process may also be provided by which users can see that their suggestions are being heard (when an administrator reads them, responses from the administrator, etc.) so that users feel like their feedback is being used and that they are being heard.

Automated Suggestions

By analyzing (data mining) engagement trends over a large number of users, the system may determine which types of engagements are going to be the most valuable to a user for increasing a user's value, social/discovery points, or action points. Accordingly, automated suggestions will help users who are low in ranking determine what to do next, similar to what credit bureaus suggest people to do in order to increase credit scores.

Custom Support Priority Queue

Users who are ranked higher can be automatically prioritized in a support queue.

User Competitions

The system may also use user relevance scores to give prizes (could be a virtual badge for bragging rights or something physical) to the top users. Top users can be calculated over any time window.

Gifting Points

Points may be gifted to boost a user's relevance ranking In exemplary embodiments, users with a large number of social points are allowed to “boost” other content by assigning extra points to it. The higher a user is ranked (social points) the more points the user may be allowed to give to other content on the site. Points may be provided via a channel (e.g., area of a website) for such users (referred to as taste makers) to temporarily increase the relevance and ranking of a band, a video, a song, a profile, or any other content on the site. Users can have a set number of points they can gift every 24 hours (rolling) that will recharge over time. In exemplary embodiments, points may not increase beyond the daily maximum for the user.

Top Fan

In view of the above, based on the ranking and/or level of engagement of a user, a top fan of a particular resource/page of a social network site may be identified. In one or more embodiments a top fan is a user who directly interacts with content or a page of a social network site. All interaction between a user and content/resource acts to increase the user's “top fan” status. Thus, by connecting to an artist/song and/or creating a mix that includes a particular artist will all serve to increase the top fan status of a user. In addition, actions beyond the mere consumption of content (e.g., listening to an artist's song) will serve to further improve the user's top fan status. For example, a user's top fan status may be based on a user's inserted positive comments about content/page, whether a user has recommended such content to a user, whether a user has indicated attendance at an event (or multiple events) relating to the content/page (e.g., a concert corresponding to an artist's page), whether a user frequently posts comments on the content's page, whether a user's friends have interacted with content based on a user's initial interaction with such content, etc. Accordingly, a top fan is based on all interactions with content/resource.

Users (including owners of content/resource/page) may view an ordered list of users' top fan statuses. Such a list would enable the owner to get to know their audience more and the affect they have on the user's content. Further, such a list would allow the owner to reward top fans for their interaction. For example, an artist owner could reward top fans with backstage passes to a concert, priority ticket purchase capability, priority download access to new releases, signed autographs, exclusive access to meet and greets, etc. An addition, a user's view of the top fans, including an identification of the current user's ranking within that list would provide the user with useful information and potentially motivate the user to increase his/her interaction to improve his/her top fan status.

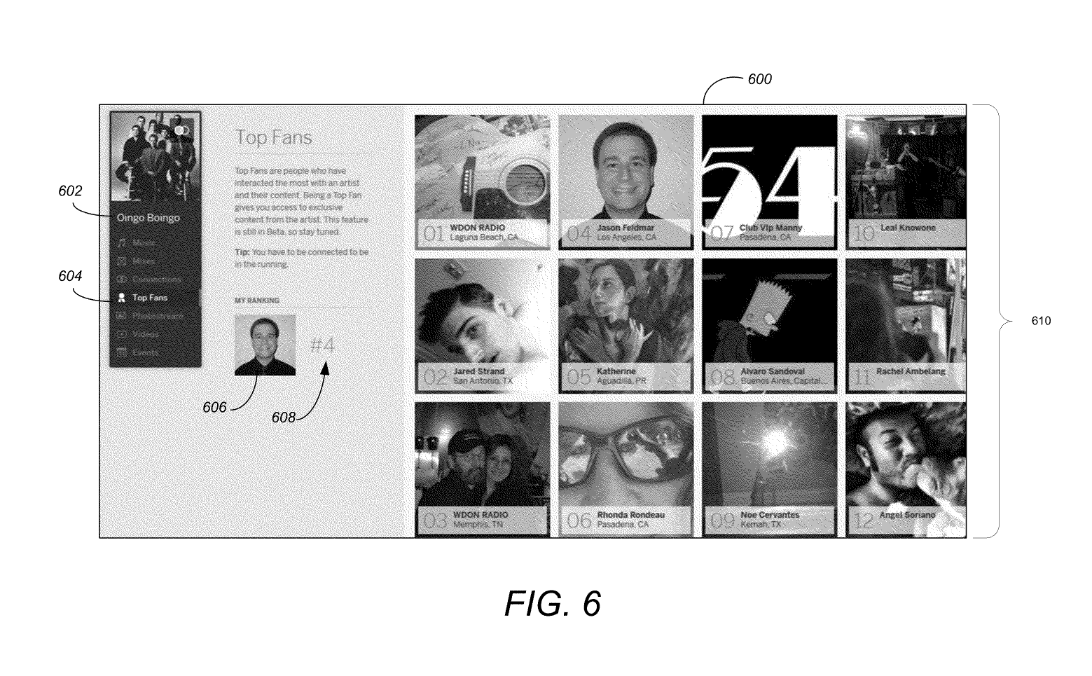

FIG. 6 illustrates a top fan page available to a user of content/resource in accordance with one or more embodiments of the invention. The logged-in user has identified a band—“Oingo Boingo” 602 (e.g., by selecting the band from an activity stream or from search results). Thereafter, the user has selected the top fan menu option 604 causing window 600 to be displayed. If the user has connected with the resource/content, an identification of the user 606 (e.g., an icon with the user's selected profile picture) is displayed along with the user's ranking 608 within the list of top fans. Adjacent thereto is the ordered list/chart 610 of the top fans for the identified band 602. As illustrated, the list 610 may show the top 12 fans and or a smaller larger list based on the size of the icons displayed within list/chart 610. The number/size of icons displayed within list/chart 610 may be selected/modified by the user. Alternatively, the size may be established by the social network site and may not be modified.

In view of the above, embodiments of the invention provide for a top fans area of a social network site that highlights the most important or influential fans in an artist or profile audience. Anytime a person interacts with a profile's content, their ranking will increase a little. Any time a person influences someone else to interact with that artist, their ranking increases a lot. Further, different types of interactions may have a greater/lesser affect than other interactions.

### Logical Flow

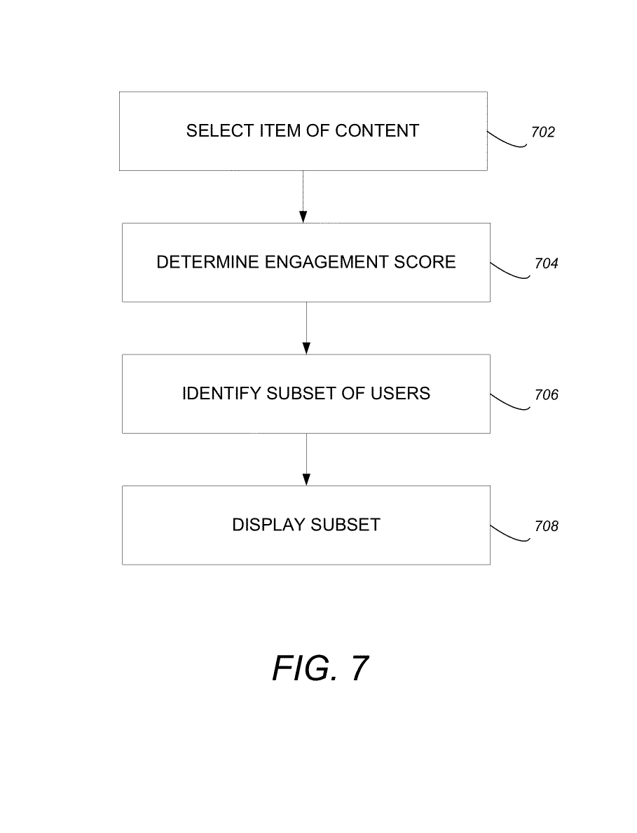

FIG. 7 illustrates the logical flow for displaying top fan status information relating to selected content in a social network in accordance with one or more embodiments of the invention.

At step 702, an item of content is selected in a social network application.

At step 704, an engagement score for each of one or more first users is determined. Each engagement score is based on interactions of each of the first users with the selected item of content. The engagement score may further based on whether additional users have accessed the item of content based on the interaction of one of the first users, interaction other than consumption of the content (e.g., the creation of a mix that includes or is associated with the item of content), etc. Alternatively or in addition, the engagement score may increase more when additional users have accessed the item of content based on such an interaction compared to an increase of the engagement score resulting from other types of interactions with the item of content.

At step 706, a subset of the users that have interacted with the item of social content the most is identified.

At step 708, the identified subset is displayed. Such a subset may include an identification of a predefined number of first users sorted by highest-to-lowest engagements score (e.g., a list of top fans based on the engagement score). In addition to displaying the identified subset, the logged-in user's ranking amongst all of the first users (based on engagement score) may be displayed.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for displaying top fan status information relating to selected content in a social network comprising:
selecting an item of content in a social network application;
determining an engagement score for each of one or more first users, wherein each engagement score is based on interactions of each of the one or more first users with the selected item of content;
identifying which of the one or more first users has interacted with the item of social content the most; and
displaying a subset of the one or more first users based on the identifying.

2. The computer-implemented method of claim 1, wherein the engagement score is based on whether additional users have accessed the item of content based on the interaction of one of the first users.

3. The computer-implemented method of claim 2, wherein the engagement score increases more when additional users have accessed the item of content based on the interaction of one of the first users compared to an increase of the engagement score resulting from other types of interactions with the item of content.

4. The computer-implemented method of claim 1, wherein the engagement score is based on interaction other than consumption of the item of content.

5. The computer-implemented method of claim 1, wherein the engagement score is based on a creation of a mix that includes or is associated with the item of content.

6. The computer-implemented method of claim 1, further comprising displaying the logged-in user's ranking amongst all of the one or more first users based on the engagement scores.

7. The computer-implemented method of claim 1, wherein the subset comprises an identification of a predefined number of the one or more first users sorted by highest-to-lowest engagement score.

8. A system for displaying top fan status information relating to selected content in a social network comprising:
(a) a server computer;
(b) a social network application executing on the computer; wherein the social network application is configured to:
(1) select an item of content in a social network application;
(2) determine an engagement score for each of one or more first users, wherein each engagement score is based on interactions of each of the one or more first users with the selected item of content;
(3) identify which of the one or more first users has interacted with the item of social content the most; and
(4) display a subset of the one or more first users based on the identifying.

9. The system of claim 8, wherein the engagement score is based on whether additional users have accessed the item of content based on the interaction of one of the first users.

10. The system of claim 9, wherein the engagement score increases more when additional users have accessed the item of content based on the interaction of one of the first users compared to an increase of the engagement score resulting from other types of interactions with the item of content.

11. The system of claim 8, wherein the engagement score is based on interaction other than consumption of the item of content.

12. The system of claim 8, wherein the engagement score is based on a creation of a mix that includes or is associated with the item of content.

13. The system of claim 8, wherein the social network is further configured to display the logged-in user's ranking amongst all of the one or more first users based on the engagement scores.

14. The system of claim 8, wherein the subset comprises an identification of a predefined number of the one or more first users sorted by highest-to-lowest engagement score.
